(19) United States
(12) Patent Application Publication
(10) Pub. No.: US 2006/0014121 A1
(43) Pub. Date: Jan. 19, 2006

(54) Multi-tooth flosser

(76) Inventor: Mark DelGrosso, Niantic, CT (US)

Correspondence Address: Mark DelGrosso, 180 Flanders Road, Niantic, CT, 06357, US

(21) Appl. No.: 10/967,600

(22) Filed: Oct. 18, 2004

Related U.S. Application Data
(60) Provisional application No. 60/587,939, filed on Jul. 14, 2004.

(51) Int. Cl. A61C 15/00

(52) U.S. Cl. 433/216; 132/323

(57) ABSTRACT

A multi-tooth flosser is disclosed. The multi-tooth flosser comprises a length of dental floss and a tray having a wall defining an interior and an exterior. The wall includes a top and a bottom opposite the top. The tray has receivers formed in the wall proximate the top and configured to receive and retain the dental floss. The tray is configured to fit inside a mouth having at least one tooth. The interior of the tray receives at least one tooth. The dental floss disposed in the tray is configured to simultaneously pass between inter-proximal spaces of the at least one tooth.

### PRIORITY CLAIM

This Application claims priority to Provisional Patent Application No. 60/587,939 filed on Jul. 14, 2004.

### BACKGROUND

The purpose of both brushing and flossing is to reduce the number of bacteria that inhabit the oral cavity. The American Dental Association (ADA) recommends brushing twice a day and cleaning between the teeth with a dental floss or an inter-dental cleaner once each day to remove plaque from all tooth surfaces. Plaque is responsible for both tooth decay and gum disease.

Dental floss is available in several different varieties including waxed or unwaxed, flavored or unflavored, and regular or tape types. Although the benefits of flossing have been documented, flossing is not practiced as much as brushing. Flossing is considered time consuming and when not used appropriately, the floss may hurt the fingers when used. Therefore, several flossing devices have been invented to help people floss their teeth.

Currently, a number of flossing devices are available to the public. A popular flossing device is the flosser and dental pick. This device has a choice of two interchangeable attachments (i.e., a power ergonomic flosser and soft mint dental pick). This device is designed to reach between teeth and below the gum line to remove plaque. The drawback of this device is that only one tooth at a time can be cleaned.

Another popular device for flossing is a stemmed flosser. This device is also designed to clean below the gum line and between teeth in order to help reduce gingivitis and some forms of gum disease. The elongated stem and specially designed floss bow makes it easier to use for reaching the back of the teeth. Again, the drawback of this device is that only one tooth at a time can be cleaned.

Several flossing devices include a simple flossing stem design with extra options. One such flosser includes a floss advancing wheel in order to provide clean floss every time the device is used. Still, the drawback of this device is that only one tooth at a time can be cleaned.

What is needed in the art is a flossing device that is able to floss several teeth at one time.

### SUMMARY

The disclosure is directed toward multi-tooth flosser. The multi-tooth flosser comprises a length of dental floss and a tray having a wall defining an interior and an exterior. The wall includes a top and a bottom opposite the top. The tray has receivers formed in the wall proximate the top and configured to receive and retain the dental floss. The tray is configured to fit inside a mouth having at least one tooth. The interior of the tray receives at least one tooth. The dental floss disposed in the tray is configured to simultaneously pass between inter-proximal spaces of the at least one tooth.

The disclosure is directed toward a method of using a multi-tooth flosser. The method comprises positioning the multi-tooth flosser to be disposed in a mouth. The multi-tooth flosser includes a length of dental floss and a tray having a wall defining a channel having an interior and an exterior. The wall includes a top and a bottom opposite the top. The tray has receivers formed in the wall proximate the top. The receivers are configured to receive and retain the dental floss. The method also comprises positioning the multi-tooth flosser in the mouth, such that at least one tooth is disposed in the interior of the channel. The method also comprises passing the dental floss between inter-proximal spaces of the at least one tooth in a coordinated fashion by applying pressure on the exterior of the tray and removing the tray from the mouth.

The disclosure is directed toward a multi-tooth flosser that comprises a length of dental floss and a frame having a first wall and a second wall. The first wall and the second wall have an interior, an exterior, a top and a bottom. The first wall and the second wall are joined by at least one support joint and form an open space for receiving at least one tooth. The frame has receivers configured to receive and retain the dental floss spanning the open space. The frame is configured to fit inside a mouth having at least one tooth. The dental floss is disposed in the frame and configured to pass between inter-proximal spaces of the at least one tooth at the same time.

The disclosure is directed toward a multi-tooth flosser comprising a tray having an interior, an exterior, a top and a bottom. The tray has receivers disposed on the top and configured to receive and retain dental floss. The tray is configured to fit inside a mouth having at least one tooth. The interior of the tray receives at least one tooth. The dental floss is disposed in the tray and is configured to pass between inter-proximal spaces of the at least one tooth at the same time.

### BRIEF DESCRIPTION OF THE FIGURES

Referring now to the figures, wherein like elements are numbered alike:

FIG. 1 is a perspective view of an exemplary embodiment of the multi-tooth flosser.

FIG. 2 is a perspective view of another exemplary embodiment of the multi-tooth flosser.

FIG. 2A is a perspective view of another exemplary embodiment of the multi-tooth flosser.

FIG. 3 is a perspective view of an exemplary embodiment of the multi-tooth flosser having a handle.

FIG. 4 is an exemplary handle that is removable from the multi-tooth flosser.

FIG. 5 is a side view of several receivers disposed on the multi-tooth flosser.

FIG. 6 is a side view of several receivers disposed on the multi-tooth flosser.

FIG. 7 is a perspective view of a portion of an open channel of the multi-tooth flosser.

FIG. 8 is a perspective view of another exemplary embodiment of the multi-tooth flosser having a dental floss dispenser.

FIG. 9 is a perspective view of another exemplary embodiment of the multi-tooth flosser having an upper tray connected with a lower tray.

FIG. 10 is a side view of another exemplary embodiment of the multi-tooth flosser being disposed in an individual's mouth.

FIG. 11 is a side view of the multi-tooth flosser of FIG. 1 as disposed in an individual's mouth.

### DETAILED DESCRIPTION

Persons of ordinary skill in the art will realize that the following disclosure is illustrative only and not in any way limiting. Other embodiments of the invention will readily suggest themselves to such skilled persons having the benefit of this disclosure.

The present invention is designed to fit the entire maxillary and mandibular arches, while flossing more than one tooth at a time. It is designed in such a way, that when inserted into the individual's mouth, it will cover all upper and/or lower teeth, and dental floss will pass between the inter-proximal spaces of more than one tooth at the same time (i.e., in a coordinated fashion).

While the product can be designed to be custom-based (i.e., individualized for each patient's needs) it has also been envisioned to be a universal-type multi-tooth flosser. A universal-type multi-tooth flosser can utilize, for example, three sizes: small, medium and large. The present invention can floss all the teeth at the same time, saving time and energy.

Although u-shape is preferred, the multi-tooth flosser can be v-shaped, square-shaped, rectangular-shaped, and the like. The multi-tooth flosser can be segmented pieces or a uniform body. The multi-tooth flosser can be formed in segmented pieces or as one contiguous piece.

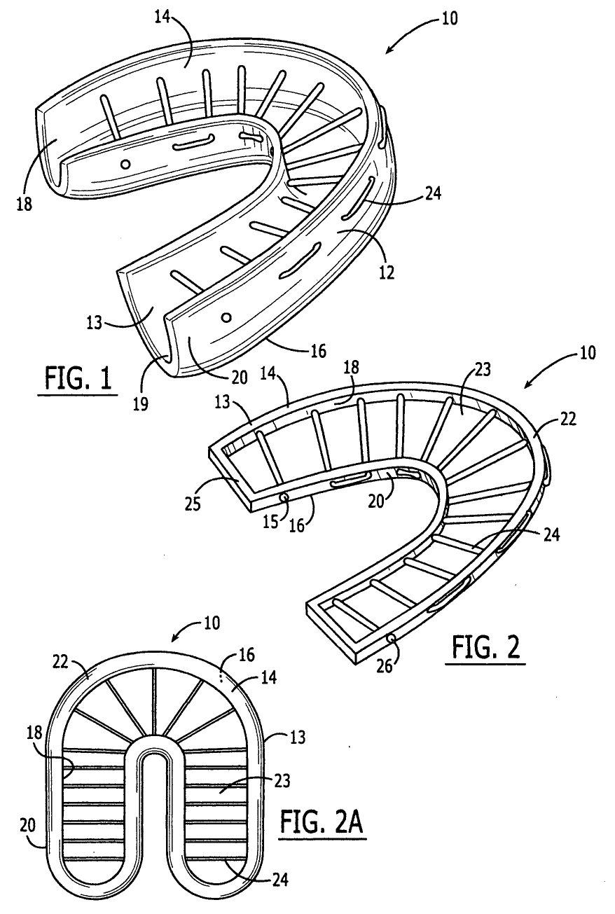

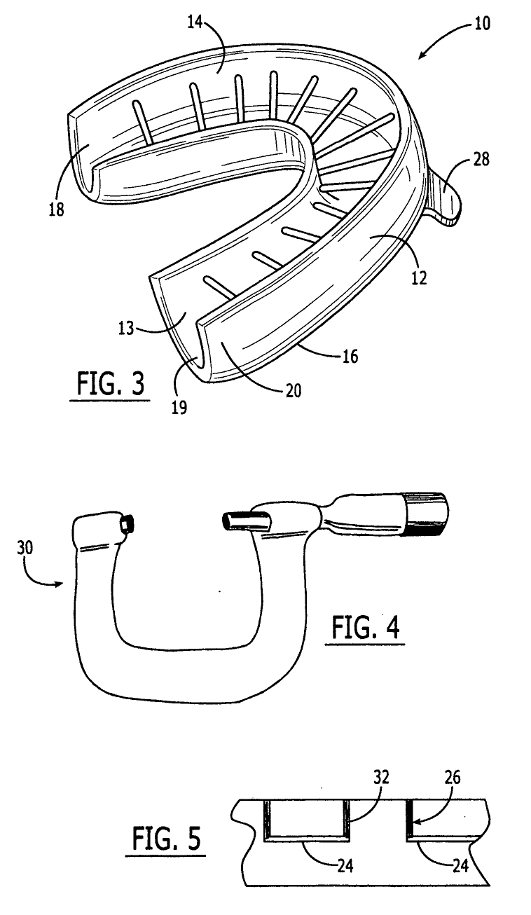

Referring to FIG. 1, an exemplary multi-tooth flosser 10 is illustrated. The multi-tooth flosser 10 includes a tray 12 having a wall 13 including a top 14 and a bottom 16 opposite the top 14. The wall 13 defines an interior 18 and an exterior 20. The wall 13 forms a semi-circular (or square, u-shape, v-shape, or the like) channel 19 in order to receive teeth in the interior and to allow for the dental floss to span the opening (i.e., top) of the channel. Although the embodiment in FIG. 1 illustrates the dental floss 24 extending through the tray 12 from the interior 18 to the exterior 20, other embodiments may include the dental floss not extending to the exterior 20 of the tray 12 (See FIG. 3) or the tray 12 having a separate channel (or groove or trench) 35 within the wall 13 (See FIG. 7), which encases the dental floss.

The tray 12 is fabricated of a material having properties compatible for use in an individual's mouth. It is contemplated that the tray 12 can be designed to custom fit a particular individual's mouth or it can be designed to be a universal device being available in standard sizes (e.g., small, medium, and large). The dimensions of the tray 12 can vary having a length of about 2 inches to about 3 inches, with a width of about 2 inches to about 4 inches. The height of the tray is dependent upon the type of tray utilized.

In an exemplary embodiment illustrated in FIG. 2, the multi-tooth flosser 10 has a framework (or frame) 22 that houses dental floss 24 in receivers 26. The frame 22 has a first wall 13 and a second wall 15 that are joined by support joints 25 and to further support the frame 22. Each wall 13, 15 has a top 14 and a bottom 16 opposite the top 14. Each wall 13, 15 defines an interior 18 and an exterior 20. Each wall 13, 15 forms a semi-circular (or square, u-shape, v-shape, or the like) shape in order to receive teeth. The frame 22 has an open space 23 that allows for the dental floss to span the open space and for the teeth to pass through the frame 22. The frame 22 is made of a material that is sturdy enough to withstand the pressure of use of the multi-tooth flosser 10. The material can also be configured to be sterilized for reuse or disposable. Although the embodiment in FIG. 2 illustrates the dental floss 24 extending through the frame 22 from the interior 18 to the exterior 20, other embodiments may include the dental floss not extending to the exterior 20 of the frame 22 (as demonstrated in the tray 22 of FIG. 3) or the frame 22 having a separate channel within the wall 13 (as demonstrated in the tray 22 of FIG. 7), which encases the dental floss.

In another exemplary embodiment illustrated in FIG. 2A, the multi-tooth flosser 10 has a framework (or frame) 22 that houses dental floss 24. The frame 22 has a wall 13 with a top 14 and a bottom 16 opposite the top 14. The wall 13 defines an interior 18 and an exterior 20. The wall 13 forms a semi-circular (or square, u-shape, v-shape, or the like) shape in order to receive teeth. The frame 22 has an open space 23 that allows for the dental floss to span the open space and for the teeth to pass through the frame 22. The frame 22 is made of a material that is sturdy enough to withstand the pressure of use of the multi-tooth flosser 10. The material can also be configured to be sterilized for reuse or disposable. The dental floss 24 can extend through the frame 22 from the interior 18 to the exterior 20, the dental floss can not extend to the exterior 20 of the frame 22 or the frame 22 can have a separate channel within the wall 13 (as demonstrated in the tray 22 of FIG. 7), which encases the dental floss.

As illustrated in FIGS. 3 and 4, the tray 12 or frame 22 can have a handle 28, 30 for ease in disposing (inserting) the multi-tooth flosser 10 in an individual's mouth. The handle 28 can be formed integral with the tray 12 as illustrated in one embodiment in FIG. 3. Preferably, the handle 28 extends about 1 inch from the tray 12. The handle 28 can extend from the front portion as illustrated in FIG. 3, or from the bottom of the multi-tooth flosser 10 for ease in inserting the device into a mouth. Alternatively, the handle 30 can be separately attached to the multi-tooth flosser 10 as illustrated in another embodiment in FIG. 4. Any device that is removable and can act as a handle 30 to help guide the multi-tooth flosser 10 into an individual's mouth is also contemplated.

The multi-tooth flosser 10 can be designed to be used permanently with dispensable dental floss 24, the multi-tooth flosser 10 can be used semi-permanently until the permanently secured dental floss 24 wears out, or the multi-tooth flosser 10 can be disposable for a one time use. The dental floss 24 can be installed by the manufacturer such that the dental floss 24 cannot be removed by the consumer (i.e., the floss is tied off) or the consumer can manually install the dental floss 24 into the receivers 26 of the multi-tooth flosser 10.

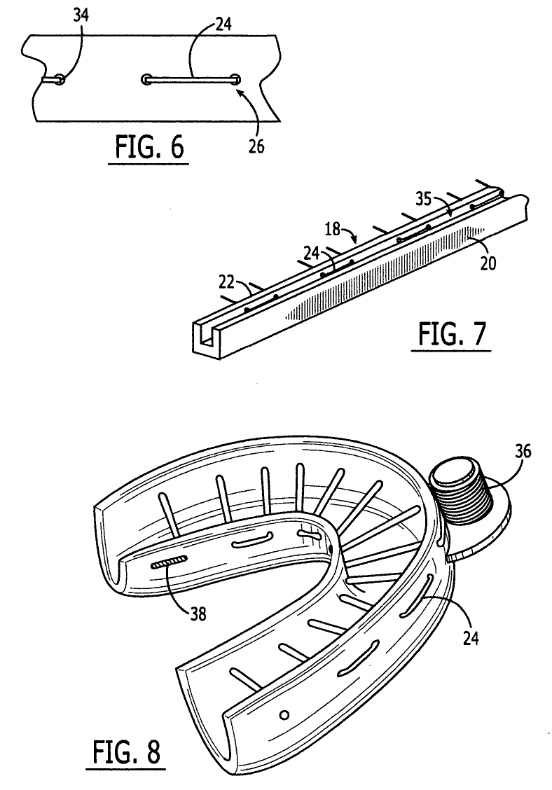

Referring now to FIGS. 5 and 6, side views of the multi-tooth flosser 10 are presented. The connection of the floss 24 to the tray 12 (or the frame 22) of the multi-tooth flosser 10 can be accomplished in several different receivers 26. In an exemplary embodiment, illustrated in FIG. 5, the receivers are slits (or cuts or cutouts or vertical depressions) 32 disposed in the top of the tray 12 for manual installation of the floss 24 by the consumer. In another exemplary embodiment illustrated in FIG. 6, apertures (or holes or vias) 34 can be disposed in the tray 12 for pulling the floss 24 through the tray 12.

In yet another exemplary embodiment illustrated in FIG. 7, a perspective view of a portion of an embodiment of the multi-tooth flosser 10 is shown. The floss 24 is disposed in a trench 35 formed between the interior 18 and the exterior 20 of the tray 12. The trench 35 can be opened for ease in changing floss 24 or it can be completely closed, encasing the floss 24 within the trench 35.

In an exemplary embodiment as illustrated in FIG. 8, the multi-tooth flosser 10 is equipped with a floss dispenser 36 that can dispense floss 24 as needed through the multi-tooth flosser 10. In this embodiment, it is contemplated that the multi-tooth flosser 10 has an end lock 38 that holds the dental floss 24 in place while allowing for easy (securing) locking and (releasing) unlocking of the dental floss 24.

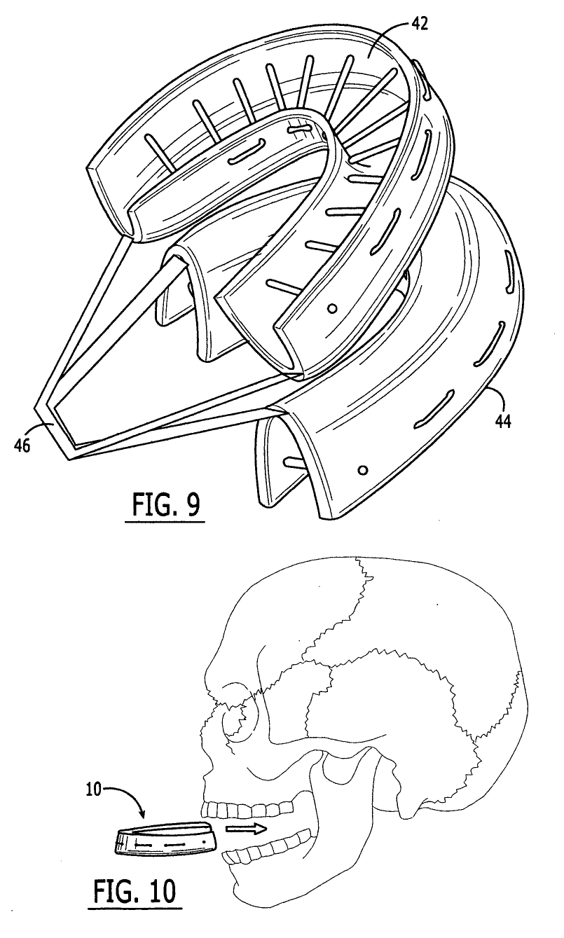

The tray 12 can be universally designed to fit both sets of teeth in either the upper or lower jaw. In other exemplary embodiments, the multi-tooth flosser 10 can be custom made to fit the teeth of either the upper or lower jaw. In yet another exemplary embodiment as illustrated in FIG. 9, the multi-tooth flosser 40 is designed to floss both the upper and lower teeth at the same time. An upper tray 42 can be connected to a lower tray 44 by a coupler (e.g., hinge) 46. The coupler can be a spring loaded hinge or a linkage, or the like.

The type of dental floss 24 utilized depends upon the desires or needs of the consumer. All varieties of dental floss 24 can be utilized in the multi-tooth flosser 10. Several examples of dental floss 24 include, but are not limited to, waxed or unwaxed, flavored or unflavored, and regular or tape types.

The tray 12 or frame 22 for a universal multi-tooth flosser 10 can be designed for small, medium and large oral configurations, similar to those maxillary and mandibular casts used for teaching purposes in dentistry. The procedure can be applicable to the universal multi-tooth flosser 10, as well as to a custom-fitted multi-tooth flosser 10.

The tray 12 or frame 22 can be comprised of several different materials, as long as the materials are biocompatible with the mouth. Dental casting alloys may be utilized, which provide many benefits. Dental casting alloys are biocompatible, provide an easy means for melting, casting, brazing, or polishing, there is little shrinkage, a high wear resistance, a high strength, low sag resistance, and a high tarnish or corrosion resistance. Specific examples of metals used for dental casting alloys can include palladium, copper, silver, cobalt, gold, and gallium. The tray 12 or frame 22 can also be comprised of a base metal alloy, such as nickel, chromium, cobalt, molybdenum, aluminum, and the like. Another material that may be utilized is stainless steel. Preferably, a stainless steel that has a low content of impurities and a passivated finish.

The tray 12 or frame 22 can be comprised of denture base polymers. A sample of a denture base polymer is based on poly (methyl methacrylate) powder and a monomer mixture (liquid) of methyl methacrylate and a cross-linking dimethacrylate monomer such as ethylene glycol dimethacrylate (EGDMA).

The tray 12 or frame 22 can be comprised of synthetic polymers such as polymethyl methacrylate and its copolymers or of a plastic resin such as utilized in dentures. Another material that can be utilized is a resin-based material including composites, resin modified glass ionomers and componomers.

In one embodiment, the multi-tooth flosser 10 can be constructed using a procedure using plastic and/or Ethyl Vinyl Acetate (EVA) sheets and a STA-VAC Vacuum Machine. A STA-VAC Vacuum Forming Machine provides powerful suction and highly accurate adaptations of 5″×5″ sheet materials. Vacuum Forming Materials: 5 inch×5 inch sheet thermoplastic materials are utilized for creating a wide range of vacuum formed appliances and trays. Pure grade resin sheets are latex-free and uniform in size, cut and thickness for improved performance. These materials resist bubbling, crazing, and fracturing to promote superior adaptations every time. Clear soft EVA sheets are designed to bond together for build-up and lamination of custom mouth guards. There are several varieties of materials, for example, but not limited to, 020″ Clear Temporary Splint Material, 020″ Coping and Temporary C&B Material, 040″ Clear Bleaching Tray Material, 060″ Pink Base Plate Material, 080″ Clear Thin Mouth guard Material, 080″ Pink Tray Material, 100″ Pink Tray Material, 118″ Clear Mouth guard Material, and 150″ Clear Mouth guard Material.

The procedure is as follows. The tray 12 extends to the point where the soft tissue meets the attached gingival. The thickness of the cast (i.e., small, medium, large, or custom) should not exceed 6 mm to facilitate the vacuum formation and to minimize stretching and thinning of the vinyl plastic during the molding. For the same reason, a hole is drilled in the palate with a large pear-shaped bur. The cast is soaked in water for a few seconds to prevent the hot thermoplastic material from adhering to the cast. Excess water is removed from the cast, and the wet cast is placed on the perforated plate of a vacuum-forming device.

The following steps complete the process. A vinyl plastic blank is clamped in the frame, and is place in position to be heated. The molding temperature usually is estimated by the amount the sheet of vinyl plastic material “sags” as it softens. When the material is ready, the vacuum is turned on and the frame is moved to the molding position. The frame is held in this position until the vinyl plastic is completely adapted to the contours of the cast. The vacuum is turned off and the clamp is released from the frame. The cast is set with the mouth protector aside until it cools completely. Next, the excess material is trimmed away with a cutting device. Perforations can be made at the interproximal gingival level, on both the buccal and lingual side of each tooth. A single thread is passed beginning on the buccal side of tooth #2 and ending on the lingual side of tooth #15. If a dispenser is to be used, it can be placed on the upper face of the handle, allowing for multiple dispenses of floss, and a floss-cutting device will be positioned to only use the needed amount of floss.

The tray 12 of the universal multi-tooth flosser 10 can be made to fit the average mouth. The multi-tooth flosser 10 can be constructed by a procedure using acrylic or a Triad II System™. The Triad II™ VLC Light Curing Unit cures light activated materials using tungsten halogen lighting. An adjustable table allows the processing of all types of visible light cure materials in various appliance shapes, with or without the use of a model. The Triad™ custom tray material (i.e., original blue) and Triad TruTray™ custom tray material can be used for all applications where accuracy and stability are key. The Triad™ denture base material allows for visible light cure denture base fabrication relines and repairs, as well as orthodontic appliances, custom trays, provisional crown and bridge units, and many other applications.

The trays have been designed to be made on the basis of small, medium and large casts, similar to those used for teaching purposes in dentistry. First, the cast is painted with two layers of tinfoil substitute to prevent the acrylic resin from sticking. Next, base plate wax can be used to generously block out (i.e., fill in) all undercuts within the tray area outlined on the cast. If auto-curing resin is to be used, and using pre-measured amounts of monomer and polymer, add the powder to the liquid and mix the materials. Allow the mix to set until it reaches the doughy stage. The resin is centered over the cast and the dough is rapidly adapted by hand to the cast's surfaces. Next, if applicable, attach the handle to the tray, ensure the handle is strong enough to withstand considerable force, and that its shape will not interfere with lip movement.

The same procedure will be used when using the Triad II system, with the exception that the resin is not prepared. A sheet of denture base material is used, and light-cured with the Triad II Curing light. In both cases, perforations will be made at the interproximal gingival level, on both the buccal and lingual side of each tooth. A single thread will be passed beginning on the buccal side of tooth # 2 and ending on the lingual side of tooth # 15. If a dispenser is to be used, it will be placed on the upper face of the handle, allowing for multiple dispenses of floss, and a floss-cutting device will be positioned to only use the needed amount of floss.

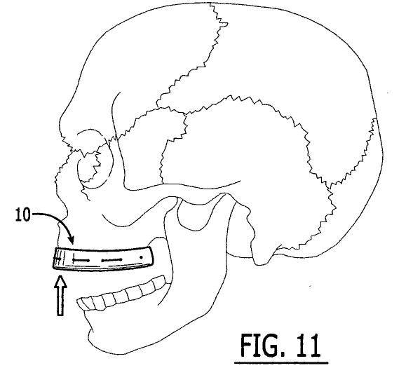

In use, the multi-tooth flosser is positioned such that it is to be disposed in a mouth, as illustrated in FIG. 10. The user opens their mouth and positions the multi-tooth flosser in the interior of the mouth in alignment with the teeth to be flossed. By applying pressure on the exterior of the tray (either upward or downward depending on teeth to be flossed), the dental floss is passed between the inter-proximal spaces of the teeth at the same time. In the tray embodiment, the teeth will contact the interior bottom of the tray as the dental floss passes between the teeth, as illustrated in FIG. 11. Similarly, by applying pressure on the exterior of the tray, removes the dental floss from between the inter-proximal spaces. The user then removes the tray from the mouth. Although a human mouth is illustrated, it is also contemplated that the multi-tooth flosser can be used for non-human oral hygiene.

The advantages of the multi-tooth flosser are the ease of flossing all teeth at one time as well as being a time saving device. The multi-tooth flosser can be custom designed to fit an individual's teeth or be of a universal design to fit a variety of individuals. Further, the multi-tooth flosser can be a dedicated device that can be used repeatedly with changeable dental floss or the multi-tooth flosser can be a disposable device being used several times or only once.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention.

What is claimed is:

1. A multi-tooth flosser comprising:
a length of dental floss; and
a tray having a wall defining an interior and an exterior, said wall includes a top and a bottom opposite said top, said tray having receivers formed in the wall proximate said top, said receivers configured to receive and retain said dental floss;
wherein said tray is configured to fit inside a mouth having at least one tooth, said interior of said tray receiving said at least one tooth, said dental floss disposed in said tray configured to simultaneously pass between inter-proximal spaces of said at least one tooth.

2. The multi-tooth flosser of claim 1, further comprising:
a floss dispenser disposed on said tray.

3. The multi-tooth flosser of claim 1, further comprising:
a handle disposed on said tray.

4. The multi-tooth flosser of claim 1, wherein said tray is custom designed to fit an individual's mouth.

5. The multi-tooth flosser of claim 1, wherein said tray is a universal design.

6. The multi-tooth flosser of claim 1, further comprising:
another tray coupled to said tray by a coupler.

7. The multi-tooth flosser of claim 1, further comprising:
a trench disposed in said wall of said tray to receive said floss.

8. A method of using a multi-tooth flosser comprising:
positioning the multi-tooth flosser to be disposed in a mouth, the multi-tooth flosser including a length of dental floss and a tray having a wall defining a channel having an interior and an exterior, said wall includes a top and a bottom opposite said top, said tray having receivers formed in said wall proximate said top, said receivers configured to receive and retain said dental floss,
positioning the multi-tooth flosser in said mouth, wherein at least one tooth is disposed in said interior of said channel;
passing the dental floss between inter-proximal spaces of said at least one tooth in a coordinated fashion by applying pressure on said exterior of said tray; and
removing said tray from said mouth.

9. A multi-tooth flosser comprising:
a length of dental floss; and
a frame having a first wall and a second wall, said first wall and said second wall having an interior, an exterior, a top and a bottom, said first wall and said second wall joined by at least one support joint and forming an open space for receiving at least one tooth, said frame having receivers configured to receive and retain said dental floss spanning said open space;
wherein said frame is configured to fit inside a mouth having said at least one tooth, said dental floss disposed in said frame and configured to pass between inter-proximal spaces of said at least one tooth at the same time.

10. The multi-tooth flosser of claim 9, further comprising:
a floss dispenser disposed on said frame.

11. The multi-tooth flosser of claim 9, further comprising:
a handle disposed on said frame.

12. The multi-tooth flosser of claim 9, wherein said frame is custom designed to fit an individual's mouth.

13. The multi-tooth flosser of claim 9, wherein said frame is a universal design.

14. The multi-tooth flosser of claim 9, further comprising:
a trench disposed in said wall of said frame to receive said floss.

15. A multi-tooth flosser comprising:
a tray having an interior, an exterior, a top and a bottom, said tray having receivers disposed on said top, said receivers configured to receive and retain dental floss;
wherein said tray is configured to fit inside a mouth having at least one tooth, said interior of said tray receiving said at least one tooth, said dental floss disposed in said tray configured to pass between inter-proximal spaces of said at least one tooth at the same time.

16. A multi-tooth flosser comprising:
a frame having a first wall and a second wall, said first wall and said second wall having an interior, an exterior, a top and a bottom, said first wall and said second wall joined together and forming an open space for receiving at least one tooth, said frame having receivers configured to receive and retain said dental floss spanning said open space;
wherein said frame is configured to fit inside a mouth having said at least one tooth, said dental floss disposed in said frame and configured to pass between inter-proximal spaces of said at least one tooth at the same time.
